(19) United States
(12) Patent Application Publication
(10) Pub. No.: US 2012/0139202 A1
(43) Pub. Date: Jun. 7, 2012

(54) WALKING AID

(76) Inventor: Jesper Sigbjornsson, Vannas (SE)

(21) Appl. No.: 13/305,001

(22) Filed: Nov. 28, 2011

Related U.S. Application Data
(60) Provisional application No. 61/419,264, filed on Dec. 3, 2010.

(51) Int. Cl. B62B 3/00

(52) U.S. Cl. 280/47.34

(57) ABSTRACT

Provided is a walking aid having a frame comprising a first and a second frame member, a grip connected with the upper part of the aforementioned first frame member, a first steerable wheel arranged on the bottom end of the aforementioned first frame member and a second wheel which is arranged on the lower end of the second frame member. The wheels are connected with the frame such that stability in a first plane is ensured for a user during an application of a vertical load on the aforementioned grip. The walking aid extends on one side of the user.

This application claims priority to U.S. Provisional Patent Application Ser. No. 61/419,264, filed 3 Dec. 2010, the complete disclosure of which is incorporated herein by reference.

### TECHNICAL FIELD

The invention relates to a walking aid consisting of a frame comprising a first and a second frame member, a grip connected with the upper part of the aforementioned first frame member, a first steerable wheel arranged on the bottom end of the aforementioned first frame member and a second wheel which is arranged on the lower end of the second frame member. The aforementioned wheels are connected with the frame such that stability in a first plane is ensured for a user during an application of a vertical load on the aforementioned grip. The walking aid furthermore extends only on one side of the user.

### PRIOR ART

Many persons, in particular senior persons, are affected by illnesses/injuries which more or less limits their ability of motion. This manifests itself by disequilibrium, for example, when carrying items (such as shopping bags) or by pain symptoms in the knee or in the hip when shifting their body weight to one side. It is known that aids with four wheels, such as known from U.S. Pat. No. 4,341,381, can drastically improve the quality of life for persons who are in this situation.

It has been shown, however, that such solutions also have disadvantages, such as the size of the construction which can either not be used at all or only with great effort in situations where space is tight. This construction moreover also requires increased use of materials and consequently expenditure.

Space-effective walking aids are known from US 2001-0038186, which contrary to U.S. Pat. No. 4,341,381, represent an apparatus which extends mainly on one side of the user. The field of application of this solution (US 2001-0038186) is limited, however, since it is intended for the support of such persons who have one completely incapacitated leg. The wheels are moreover very small and are thus usable essentially only indoors.

A transportation means which is suitable and is intended for transportation of heavy loads is known from NL 8701079. This walking aid is only suitable for limited use as a walking aid, since especially the tilt-up transportation surface would limit the user's freedom of movement and/or make it more difficult of maintaining equilibrium. Because the structure of the transportation means is rather complex, it is thus costly in terms of labor and expenditure.

WO 2006/121404 discloses a walking aid which has a similar basic construction and therefore overcomes several of the problems cited in the prior art. The cited publication however has no reference regarding the safety aspects when using the walking aid, in particular the risk of the walking aid rolling away unintentionally.

### OBJECT OF THE INVENTION

The object of the present invention is to develop a walking aid of the type mentioned at the outset to increase the safety of users, and which will minimize or overcome the disadvantages of the cited prior art, using simple measures in terms of design.

The solution of the problem is such that a walking aid comprising a frame which has a first and a second frame member, a grip connected to the upper part of the aforementioned first frame member, a first wheel arranged at the lower end of the aforementioned first frame member and a second wheel, which is arranged at the lower end of the second frame member is provided, wherein the aforementioned wheels are connected with the frame such that during a vertical application of a load on the aforementioned grip, stability in the plane is ensured for the user, wherein the said walking aid extends on one side of the user and wherein one of the cited wheels is steered by the grip and the walking aid has a safety arrangement which is configured to prevent unintentional rolling away of the walking aid.

In a preferred embodiment, the safety arrangement consists of a steering stop in the first frame member.

By adding a steering stop and/or one-way ball bearings into such walking aid, which preferably permits limiting the operation to 90°, surprising advantages are achieved. The user will perceive an increased feeling with respect to safety, because any unintended changes in direction and the associated “breakaway” of the walking aid to the side opposite of the user and/or any roll-back of the walking aid can be prevented in this way. The steering stop prevents lateral “breakaway” of the walking aid during a rapid weight distribution or steering motion, for example.

In a further preferred embodiment, in addition to or instead of the steering lock, one-way ball bearings can be installed in one or in both wheels.

The one-way ball bearings are in turn useful particularly when using the walking aid uphill, because the users have limited physical ability and/or are likely to be seniors and are thus more fragile and therefore require more frequent stops. Previously it was necessary for either having to actuate the brake (if provided), or that the user had to prevent the walking aid from rolling back using his own force. This is now ensured by the use of one-way ball bearings.

In this way, the field of application for walking aids as well as the safety of the users of such are increased significantly. Because this mostly involves physically handicapped persons, the safe handling of the walking aid must be ensured in a simple manner and with a minimum application of force.

### FURTHER ASPECTS OF THE INVENTION

in addition, a carrier can also be arranged to carry loads such as a shopping bag or similar.
the first frame member is designed rotatably relative to the second frame member, which in combination with the steerable first wheel represents a particularly elegant and cost-efficient design.
the second frame member is connected pivotable with the first frame member to facilitate a compact, space-saving embodiment.
the upper part of the frame has an armrest, which extends upwards from the grip, advantageously including a U-shaped arm support to make the use as efficient and comfortable as possible for the user.

### BRIEF DESCRIPTION OF THE FIGURES

The invention is described in detail in the following with reference to the following Figures:

FIG. 1 shows a lateral view of an advantageous embodiment of the invention

FIG. 2 is a bird's eye view of the embodiment from FIG. 1

FIG. 3 is a lateral view of the walking aid from FIG. 1 in a collapsed condition

FIG. 4 is an isometric projection of the steering stop according to the invention

FIG. 5 shows the cross-section of the steering stop from FIG. 4

### DETAILED DESCRIPTION/EMBODIMENT

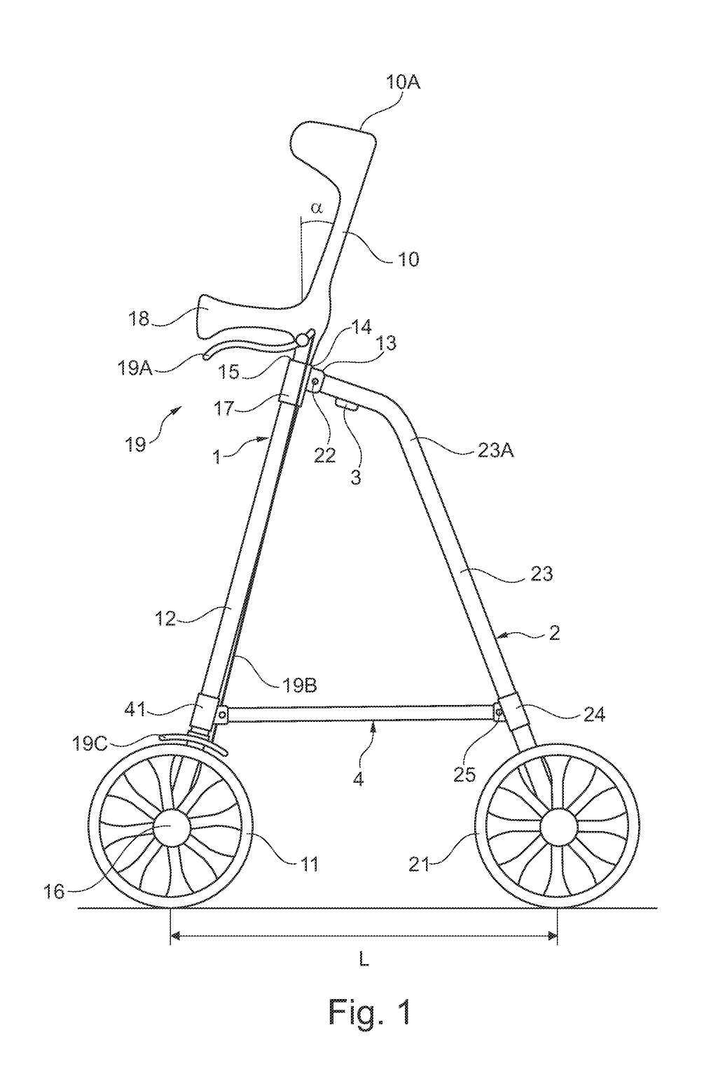

FIG. 1 represents a lateral view of an advantageous embodiment of the invention. The frame generally consists of a first frame member 1 and a second frame member 2. The first frame member 1 generally has a form of a conventional crutch 10, 12, 18, and a wheel 11 is attached on the lower end of the frame member. This part accordingly contains an oblong tube 12, on the upper end of which a plastic component 10 is attached, where the plastic component 10 has a grip 18 and a U-shaped arm support 10A.

On the upper end of the tube 12 is a bushing 17 which is fixed in the axial direction but has a ball bearing 15 between the tube 12 and the bushing 17, which makes a rotary motion of the frame member 1 in relation to the aforementioned bushing 17 possible.

The second frame member 2 is connected pivotable with the bushing 17 by means of a pivot joint 22 in the junction 13 of the bushing 17. The pivot joint 22 enables a rotary motion in the vertical plane, such as a plane which contains the tube 12. The second frame member 2 consists of a second tube 23, which has a bend 23A on its upper end. A wheel 21 is attached on the lower end of the tube 23.

A further connection exists between the first frame member 1 and the second frame member 2 in form of the connecting rod 4. The connecting rod 4 is connected pivotable with the second tube 23 with the aid of the pivot joint 25 which is arranged on the bushing 24 and is fixed with the second tube 23. At the other end of the connecting rod 4 is a further bushing 41, which is slidably connected with the first tube 12. Accordingly, the front end 41 of the connecting rod 4 can freely move and/or slide on the first tube 12. FIG. 1 shows the position of the connecting rod 4 in a position which represents the walking aid during use as taught by the invention. Accordingly, the connecting rod 4 is almost in a horizontal position between the two tubes 12, 23 to ensure a sufficient distance L between the two wheels 11, 21. The distance L should be at least 30 cm and advantageously not exceed 1 m. In the example shown, the distance L is approximately half a meter. The reason for this distance between the wheels 11, 21 is to ensure adequate stability when the walking aid is used. As follows clearly from FIG. 1, the crutch-like part 1 is affixed at an angle α in relation to the vertical line in order to deflect any potential load in the vertical direction which is exerted on the grip 18 such that this acts in the area between the two wheels 11, 21. Through this feature, the stability is ensured when the user exerts a load onto the grip 18. The angle α can be adjusted across a relatively broad range, between 10° and 60°, for example, according to the user's individual requirements. This angle was adjusted to approximately 25-35° in the example shown.

As follows from FIG. 1, a carrier 3 was attached; in this example in the form of an attachment device, to provide a simple and secure possibility for the transportation of shopping bags directly on the walking aid, for example.

In addition, a braking device 19 is shown which has a brake lever 19A adjacent to grip 18 and an actuation device comprising a rod 19B with a friction element 19C on its lower end. The braking device 19 accordingly makes it possible for the user to control the speed and/or to keep the walking aid in the rest position. The wheels 11, 21 can consist of different materials and/or have highly different forms, where it is recommended to use inexpensive mass-produced plastic wheels, however, for example such type of wheels which are already used for golf bags or similar equipment. The wheels should not be sized too small in order to facilitate use in the open and also on different types of terrain and/or substrates (snow).

To ensure wheel rotation, appropriate ball bearings are installed in the wheels 11, 21. In this preferred embodiment, a one-way ball bearing 16 is used in the first wheel 11, which permits the wheel rotation only in one direction, advantageously in the forward direction. This enables the user to keep the walking aid at standstill with less force, particularly when moving the walking aid uphill. This also minimizes the risk of accidents.

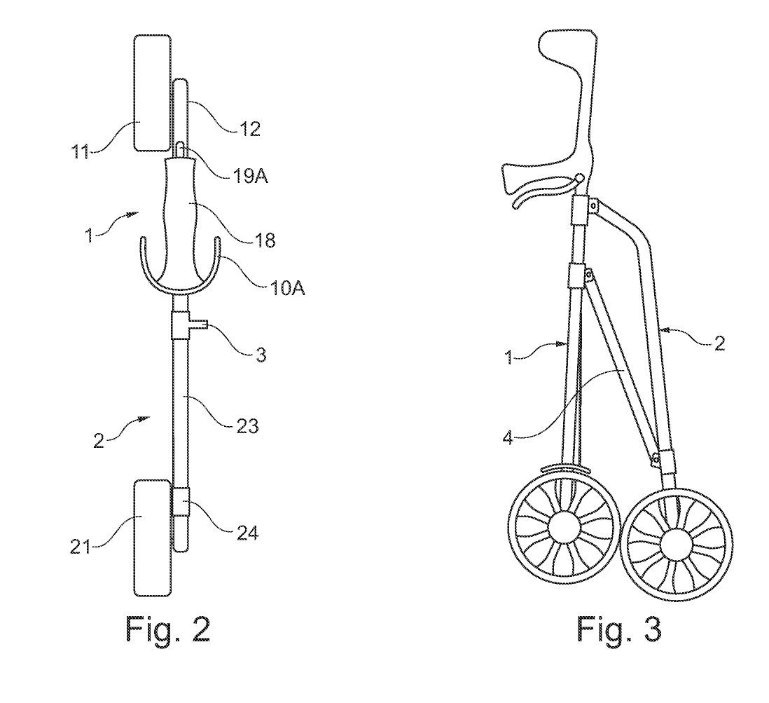

FIG. 2 shows the walking aid from above in the bird's eye view. This representation clearly shows the compact and space-saving design of the walking aid 1, 2 in one plane, i.e. how it extends mainly in the vertical plane. Thanks to this design, the walking aid can also be moved easily around busy places and moreover requires little space. This representation also makes it clear that the walking aid provides stability mainly in the direction of movement, but not in the transverse axis to the direction of movement, particularly sideways. In FIGS. 1-3 the wheels 11, 21 are attached laterally from the middle vertical plane of the frame 1, 2. But frequently it is beneficial if the wheels are attached in the extension of the middle vertical plane.

However, thanks to the invention, the first frame 1 in relation to the second frame 2 was arranged pivotable, and the front wheel 11 can thus be steered. For that reason, the user now has no difficulties in steering the walking aid whilst at the same time keeping the balance and thus also sufficiently stable during a sideways movement. The steering is similar to that of a bicycle which results in the advantageous effect that the majority of users are familiar with handling a bicycle and therefore have no difficulties with the steering. Contrary to traditional crutches, the walking aid as taught by the invention should advantageously be used on the opposite side of the leg which has a problem and/or which hurts. The walking aid 1, 2 should consequently be used advantageously on the opposite side of the leg that has the problem. This results in increased freedom of movement and simplified mobility for physically handicapped persons than would be possible with traditional crutches.

FIG. 3 shows a lateral view of the walking aid from FIG. 1, however in the collapsed condition. This collapsed condition was achieved by the upward sliding of the bushing 41 along the first tube 12, whereas the second tube 23 swivels in the pivot joint 22 and is thus moved near to the first tube 12. This extremely compact condition is particularly advantageous for the storage and/or the transportation of the walking aid.

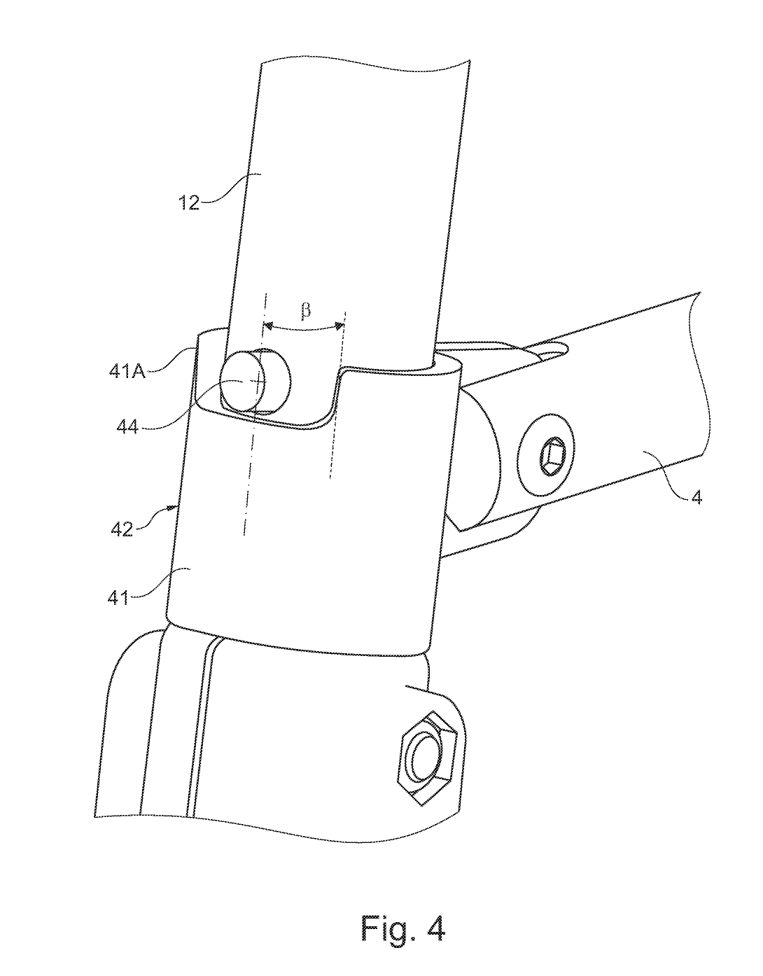

FIG. 4 shows the isometric projection of the steering stop 42. This is located in the upper part of the bushing 41 (not shown in FIG. 1). This steering stop 42 limits the angle β of the maximum steering lock of the wheel 11, since the spring plug 44 is installed in the first tube 12 and the angle β of the steering is limited by the recess 41A in the bushing 41. This angle β can be selected basically in a very wide range, for example, from plus/minus 10 to 65° (respectively measured from the center position in one direction). Advantageously, an angle of less than 50°, and in particular preferably an angle β of maximum plus/minus 35° is selected in order to prevent unintentional rolling away if the steering motion is excessive and thus preventing the breakaway of the front wheel 11 and the associated consequence of the first frame member 1 into the opposite direction of the user.

The achieved synergistic side effect is that the connection rod 4 cannot move to the top, because the bushing 41 is held in position by the spring plug 44 and cannot slide to the top along the first tube 12. This likewise increases the safety of the user, since an unintentional collapse of the walking aid can be prevented easily and efficiently.

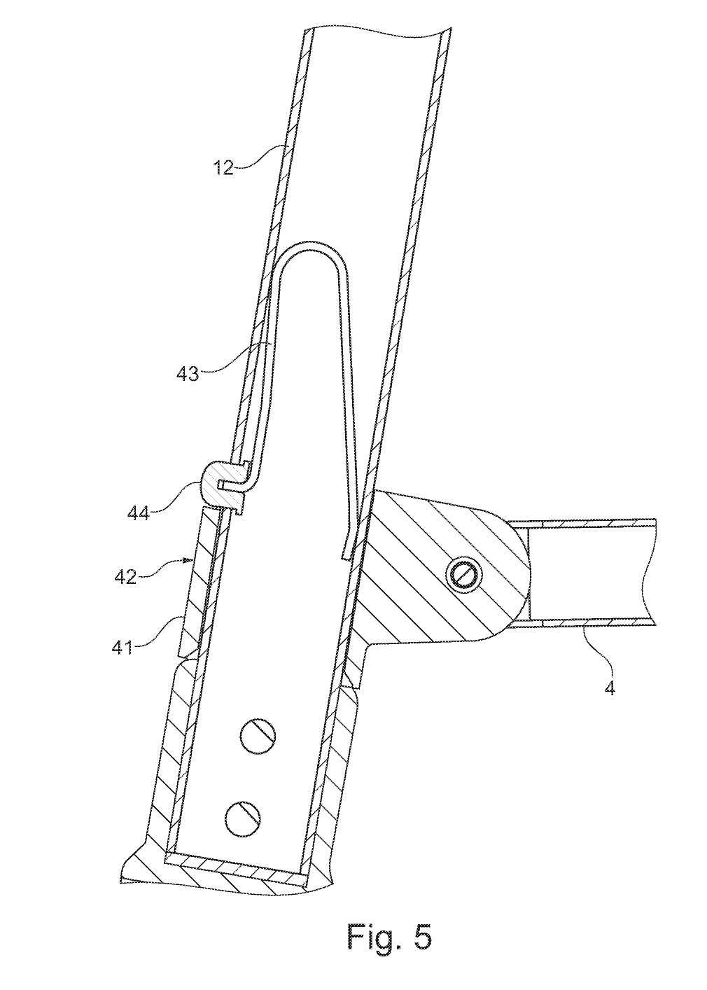

To enable collapsing the walking aid anyhow for transportation and/or storage, the spring plug 44 is arranged in the first tube 12 by a spring 43 such that the spring plug 44 can be depressed temporarily and the bushing 41 can be moved across the plug to the top at this moment. FIG. 5 shows the cross-section of the steering stop 42 and the spring 43 to illustrate this process.

A further surprising advantage by the application of the described steering stop and/or the aforementioned one-way ball bearings results in the increased freedom during the adjustment of the above-mentioned angle α. This can be advantageous when adapting the walking aid to the individual requirements of the users.

The invention is naturally not limited by the described advantageous embodiment, and corresponding modifications within the scope of the Claims are familiar to one skilled in the art. It is thus possible to remove the connecting rod 4, for example. In addition, more than two wheels can be attached or both wheels can be designed to be steered. Moreover, the aforementioned one-way ball bearing can actually be used in the second wheel and/or in all wheels. In the same way, the walking aid can be produced from all different type of materials, such as from plastic pipes, metal tubing, forged components, etc. Moreover additional components can naturally be attached on the walking aid, such as reflectors on the grip 18 or in the wheels.

1. Walking aid comprising:
a frame comprising a first frame member and a second frame member;
a grip connected with the upper end of the first frame member;
a first wheel arranged at the lower end of the first frame member;
a second wheel arranged at the lower end of the second frame member; and
a safety arrangement which is suitable to prevent the unintentional rolling away of the walking aid, wherein the wheels are connected with the frame such that during a vertical application of load on grip, stability in a first plane is ensured and wherein the walking aid extends on one side of the user and one of the wheels is constructed so that it can be steered by the grip.

2. Walking aid according to claim 1, wherein the safety arrangement comprises a steering stop which is in the first frame member.

3. Walking aid according to claim 2, wherein the steering stop creates a maximum steering lock of less than plus/minus 65° respectively based upon the center position.

4. Walking aid according to claim 2, wherein the steering stop creates a maximum steering lock of less than plus/minus 50° respectively based upon the center position.

5. Walking aid according to claim 3, wherein the steering stop creates a maximum steering lock of maximal plus/minus 35°, based upon the center position.

6. Walking aid according to claim 2, wherein the steering stop is integrated in a shiftable bushing.

7. Walking aid according to claim 6, wherein the bushing can be shifted along a tube in the first frame member and that the bushing interacts with a spring plug which in the topped out condition creates a displacement stop on both sides and the steering stop.

8. Walking aid according to claim 7, wherein the stop is created by means of a recess.

9. Walking aid according to claim 1, wherein a one-way ball bearing is arranged in one or both wheels.

10. Walking aid according to claim 9, wherein a one-way ball bearing is arranged only in the first wheel.
